(19) United States
(12) Patent Application Publication
(10) Pub. No.: US 2016/0182629 A1
(43) Pub. Date: Jun. 23, 2016

(54) Self-Configuring Network Node Data Bridge

(71) Applicant: Alliacense Limited LLC, San Jose, CA (US)

(72) Inventor: Jeremy Korn, Aptos, CA (US)

(73) Assignee: Alliacense Limited LLC, San Jose, CA (US)

(21) Appl. No.: 14/973,539

(22) Filed: Dec. 17, 2015

Related U.S. Application Data
(60) Provisional application No. 62/095,964, filed on Dec. 23, 2014.

(51) Int. Cl. H04L 29/08; H04L 12/751

(52) U.S. Cl. CPC H04L 67/1095; H04L 45/02; H04L 67/12

(57) ABSTRACT

A method to automatically build and configure a database by detecting Network Nodes on a Data Collection and Control Network and using parameters and information in the Node drivers in order to build the database and store data that is generated by the Network Nodes. The database or other storage device can be located on the local network and/or remotely on a remote device such as a computer, tablet, server, virtual machine or a cloud software instance, such that the data can be viewed and managed locally and remotely.

### FIELD

The present invention relates to the field of remote data collection.

### BACKGROUND

Remote data collection such as Internet of Things (IoT) and Supervisory Control and Data Acquisition (SCADA) systems are powerful ways to collect and store data for instant notifications and future analysis. However, the biggest challenge of remote data collection is the marriage between software and hardware, such that software engineers rarely understand hardware development and hardware engineers rarely understand software development. The self-configuring Data Bridge solves this problem with a device detection function that detects Nodes on the network and allows the user to simply add the discovered Network Nodes (such as thermometers, CO levels, relays, motors, etc.) such that the information, parameters and descriptions of these Network Nodes are stored in the Node's Device Drivers and/or Application Files, such that the Device Driver Information can be use to configure and create the specific means of data storage.

This method is enabled by simple user interface that allows any user of moderate technical ability to configure a Remote Data Collection and Control Network, where the hardware and it's associated firmware (also referred to as the “hardware system”) exists on the outward facing side of the Data Bridge and the software, databases and associated files (also referred to as the “software system”) exists on the inward facing side of the Data Bridge. The Data Bridge's ability to translate and send the hardware system's data to software platform enables independent development by hardware and software engineers.

Once the Network Nodes are added to the system, the Data Bridge generates a Database Definition File that is used to automatically build and configure a database, or databases, that are used to store the data sent from the Network Nodes.

### BRIEF DESCRIPTIONS OF THE DRAWINGS

FIG. 1 shows a common network configuration using a discrete data bridge

FIG. 2 shows a common network configuration using an integrated data bridge.

FIG. 3 shows a data bridge software architecture.

FIG. 4 shows a process flow chart for network setup and auto system configuration.

FIG. 5 shows a graphical user interface for manual setup and auto system configuration.

FIG. 6 shows a graphical user interface for viewing data on a local device.

FIG. 7 shows a graphical user interface for viewing data on a remote device.

FIG. 8 shows a system overview and process flow chart of the data bridge system software.

### DESCRIPTION OF EMBODIMENTS

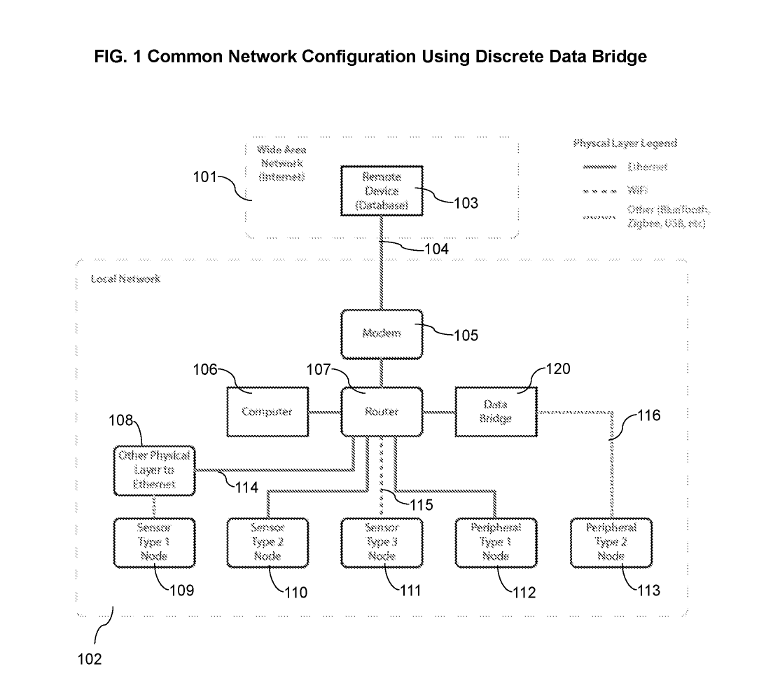

FIG. 1 shows the topology of a typical data collection and control network with example nodes types and various types of physical layer connections. This figure shows a data bridge 120 implemented as a discrete, standalone piece of equipment. A local area network 102, which may be configured within for example a home or an office, may be connected through the Internet 104 to a wide area network 101 that may comprise a remote device database which may be configured as a cloud database 104. The local area network 102 connects to the wide area network through an Internet modem 105. The Internet modem 105 connects to a router 107 through an Ethernet connection 114, which in turn may be connected through an Ethernet connection to a home computer 106. The router 107 may in turn also be connected via an Ethernet connection to a data bridge 120, to an other-physical-layer-to-Ethernet box 108, or to sensor type II node 110. The other-physical-layer-to-Ethernet box 108 may communicate, using other physical layers such as Bluetooth, ZigBee, or USB type communications, to sensor type I nodes 109. The router 107 may also be wirelessly connected to sensor type III nodes 111 or to peripheral type I nodes 112. The data bridge 120 also may include the capability to communicate to peripheral type II nodes using the alternative communication techniques such as Bluetooth, Zigbee, USB etc. Any node type can be connected to the system using any connection type. The node types are types of sensors/peripherals and not the type of interfaces on the sensors

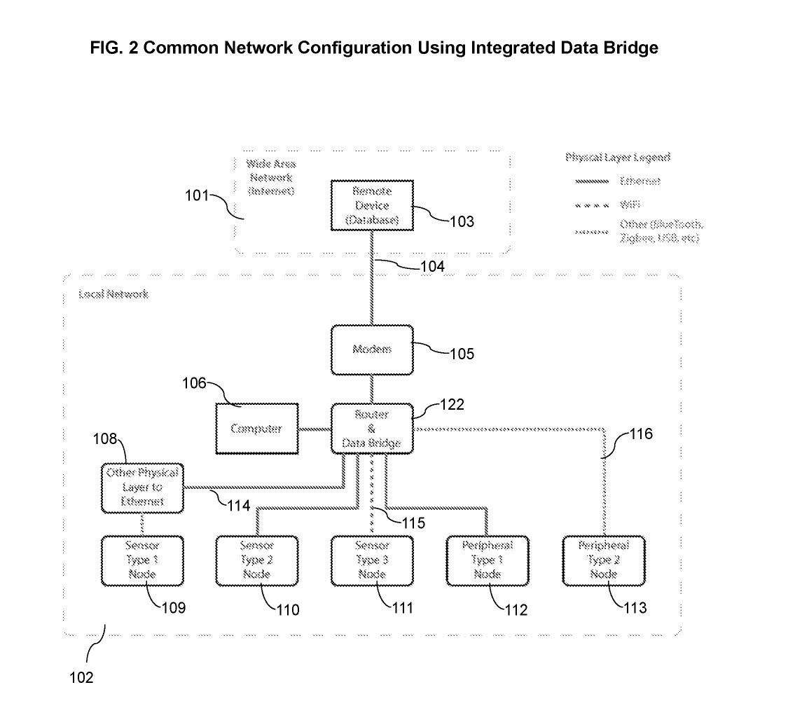

FIG. 2 shows the topology of a typical data collection and control network with example nodes types and various types of physical layer connections. The topology, devices and connections are the same as illustrated in FIG. 1 with the except that this figure demonstrates that the Data Bridge 120 may be implemented as application and core integrated into an existing piece of equipment such as a router, e.g. 107, switch, computer, or any other piece of equipment with a processor.

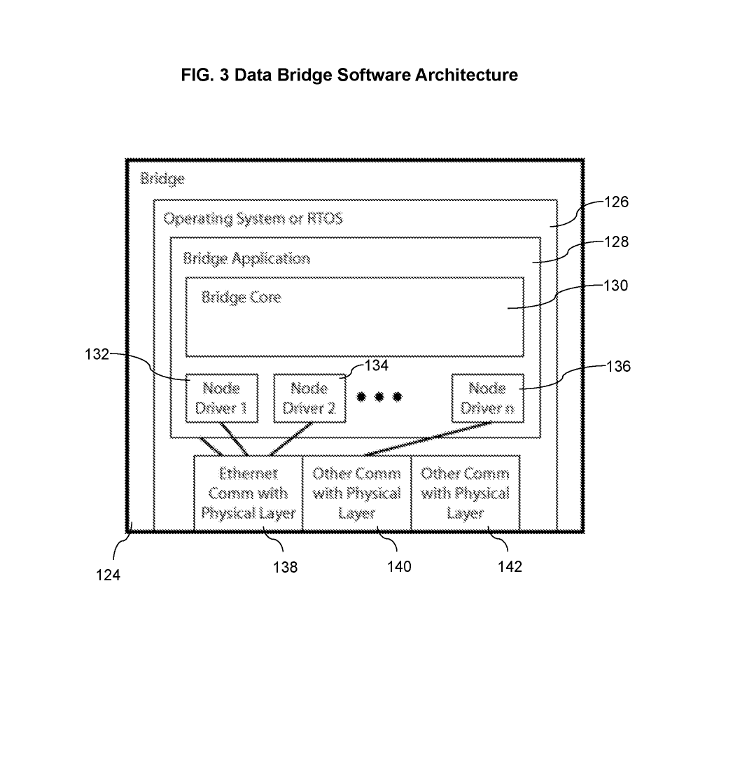

FIG. 3 shows one example of a software topology that can support the detection and auto-configuration process. The data bridge software architecture 124 employees an operating system which may be preferably a real-time operating system RTOS 126 that has a bridge application 128 that in turn communicates with a bridge core 130. The bridge applications also communicate with node drivers 1, 2 . . . n 132, 134, 136. The bridge application 128 and node drivers, 132, 134, 136 in turn respectively connect externally to physical layers for example Ethernet 138, a first type of other communication layer such as wireless 140, and still other communication type physical layers such as Bluetooth 142.

The node drivers may be specific for the type of node, preferably the no driver also includes a Commons layer connection socket, a data-in set, and a data-out set in a data translator logic. The device drivers may include device drivers for, for example the following type devices listed in Table I.

TABLE I

| | |
|---|---|
| NCD Relay Boards | Davis Weather Station |
| Applied Motion Products Stepper Motors | Atlas Scientific Temperature |
| | Modules |
| ICS 8013/8003 VXI-11 to GPIO Boards | Atlas Scientific O2 Modules |
| JDSU Spectrum Analyzer | Atlas Scientific PH Modules |
| (via SCPI commands) | |
| Anritsu Spectrum Analyzer | Atlas Scientific EC Modules |
| (via SCPI commands) | |
| Synaccess Ethernet Power Strips | Arduino WiFi Shields |
| Beagle Bone Black Ethernet Connection | Arduino Ethernet Shields |

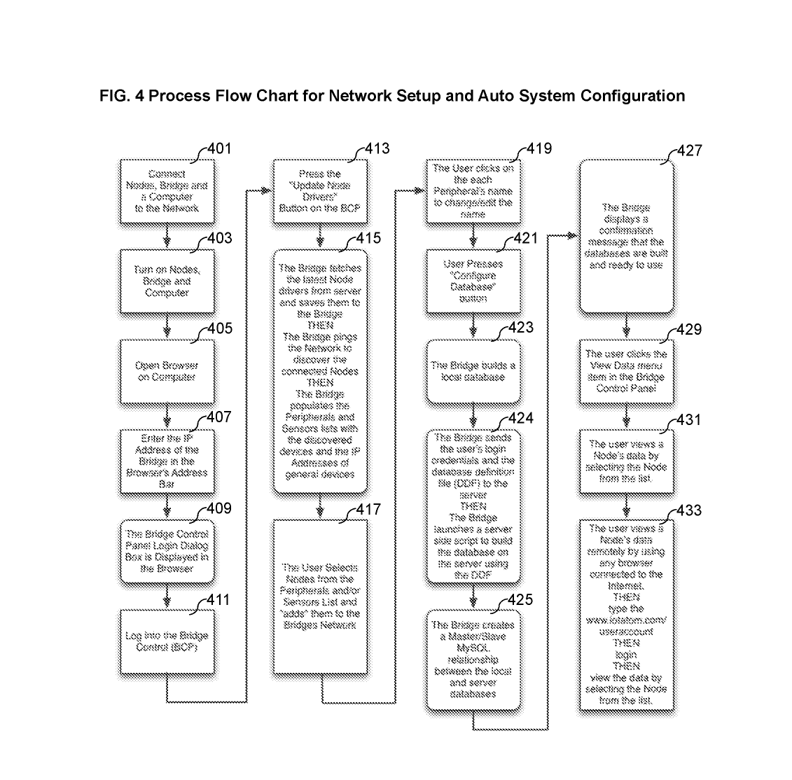

FIG. 4 shows a process flow that enables a self-configuring data bridge (120, 122) that detects network nodes and automatically builds and configures the means of data storage. At step 401, the user connects the nodes, 109, 110, 111, 112 and 113, the bridge, e.g. 120, and a computer 106 to the network 114. Next, at step 403, the user powers on these devices. At step 405, the user opens a browser on his computer. At step 407 the user enters the IP address of the bridge in the browser's address bar. At step 409, the bridge response to the browser by displaying in the browser a panel login dialog. The user may, step 411, now log into the bridge control program. The program displays, at step 413, an option for the user to an “update no drivers” button. In response to the button being pressed, the bridge control program, at step 415, fetches the latest no drivers from the server and saves them to the bridge and then the bridge pings to the network to discover the connection nodes and then the bridge populates the peripherals and sensor lists with the discovered devices and the IP addresses of general devices. Next at step 417, the user selects nodes from a list of peripherals and/or sensors listed and adds them to the data bridge network. At step 419, the user is presented the option to name each of the peripherals by clicking on its name and changing it via an edit function. At step 421 the user may press a “configure database” button. In response to the button being pressed, at step 423, the bridge software builds a local database comprising the list of nodes and data from the nodes. Next the bridge software, at step 424, since the user's login credentials in the database definition of the local database just created to the server and then the bridge software launches a server-side script to build a database on the server using a database definition corresponding to the local database. At step 425, the bridge may then create a master/slave SQL (alternatively MySQL) relationship between the local and server databases. At step 427, the bridge software displays on the user browser confirmation that the databases are built and ready to use. At step 429 the user may click a view data menu item on a bridge control panel. At step 431 the user may view a nodes data by selecting the node from the list. At step 433 the user may view a nodes data remotely by using any browser connected to the Internet and then type in the address and user account of the remote database, and then selecting from the list of nodes the particular peripheral or node of interest from a list provided.

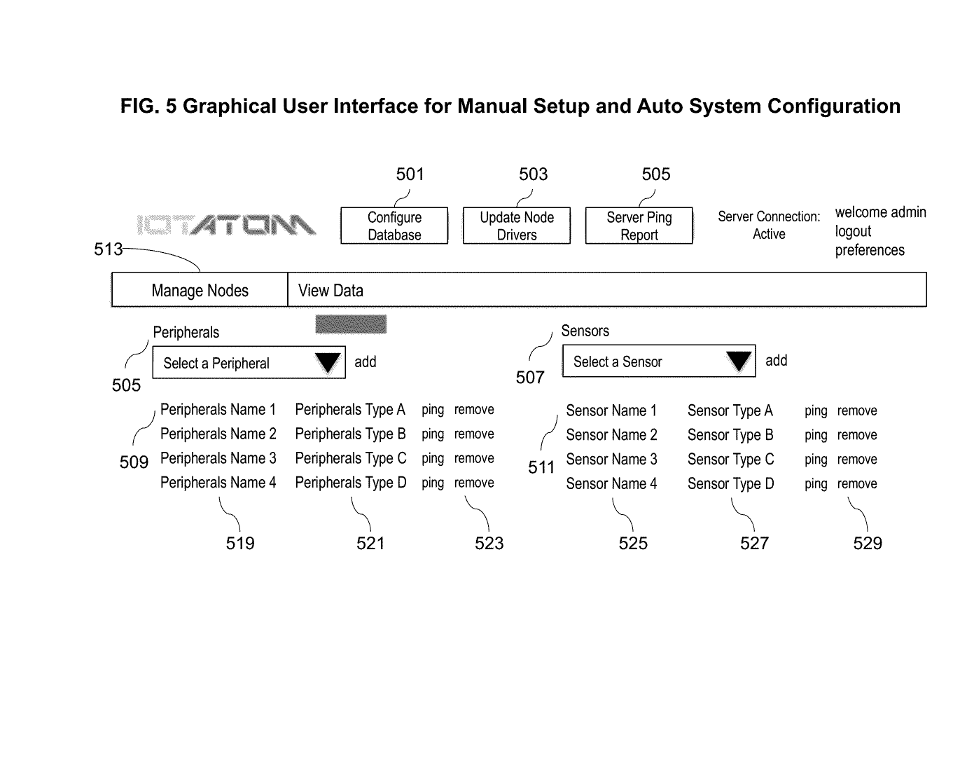

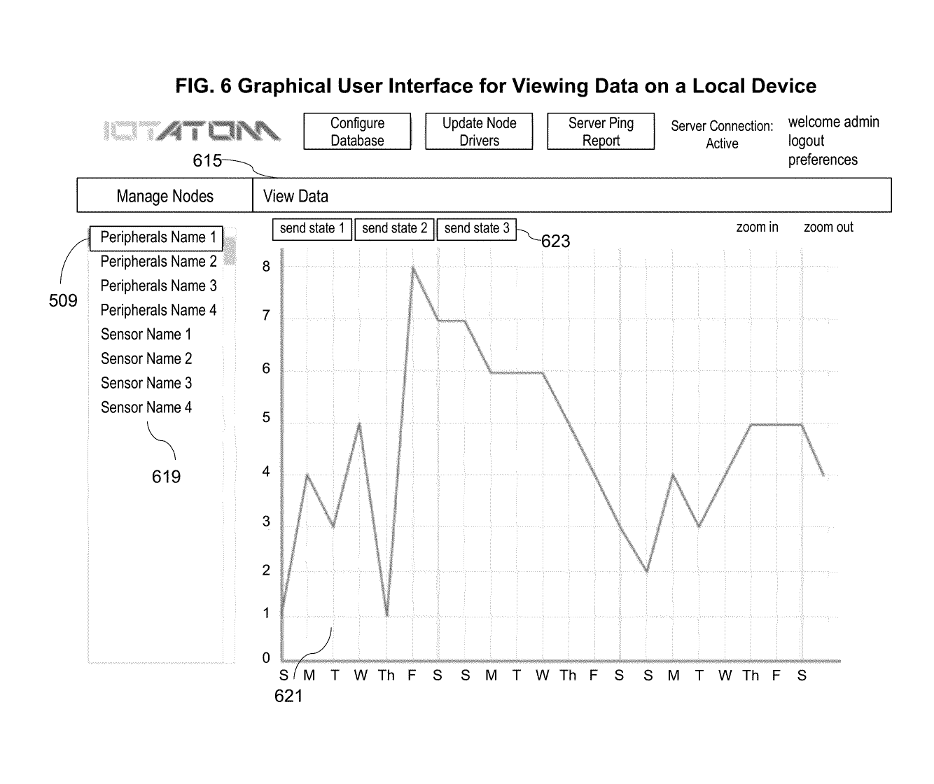

FIG. 5 shows a preferred graphical user interface that enables a self-configuring Data Bridge that detects Network Nodes and automatically builds and configures the means of data storage. The GUI includes a plurality of tabs it may include for example a configure database tab 501, an update node drivers tab 503, a server ping tab 505. A managed nodes 513 tab is displayed as opened. When this tab is opened a number of peripherals nodes 505 or number of sensors nodes 507 are displayed in the list 519 or 525 respectively. The first column in a list, either 519 or 525, would have the name of the peripheral or sensor as the case may be. The second column, 521 or 527, list the type of peripheral or sensor as the case may be. The third column, 525 or 529, displays the option to either ping or to remove the particular peripheral or sensor from the list, and thereby remove it from the respective local and remote databases. Data regarding a particular peripheral 509 or a particular sensor 511 may be viewed from a second tab “view data” as shown in FIG. 6.

FIG. 6 shows the graphical user interface for local viewing of the data that is collected from the Network Nodes. The peripherals and sensors are showed in a list 619 the individual items of which, e.g. 509, may be selected. Various kinds of data may be selected according to tabs 623. An exemplary graph 621 showing arbitrary numerical count along the abscissa, with the days of the week displayed along the ordinate.

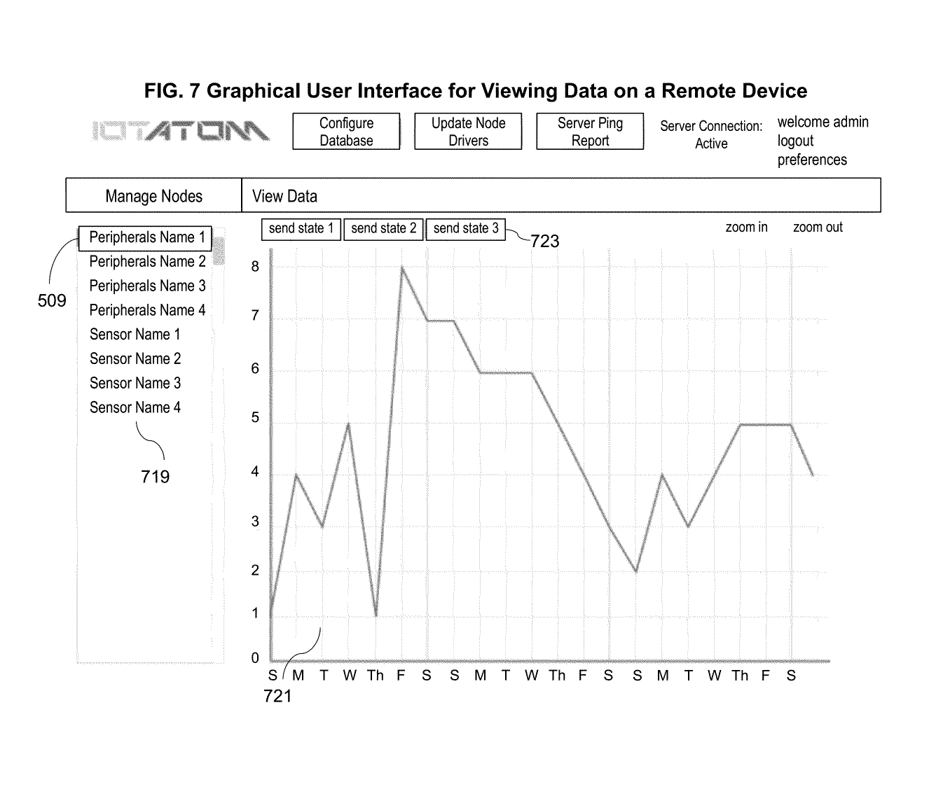

FIG. 7 shows the graphical user interface for remote viewing of the data that is collected from the Network Nodes. The remote viewing and the local viewing may use the same User Interface, or can use different User Interfaces. As shown in FIG. 7, the remote GUI employs a list of nodes 719 which are the same as the list of nodes 619 of the local display. The graphical displays 721 in the tabs 723 may be the same.

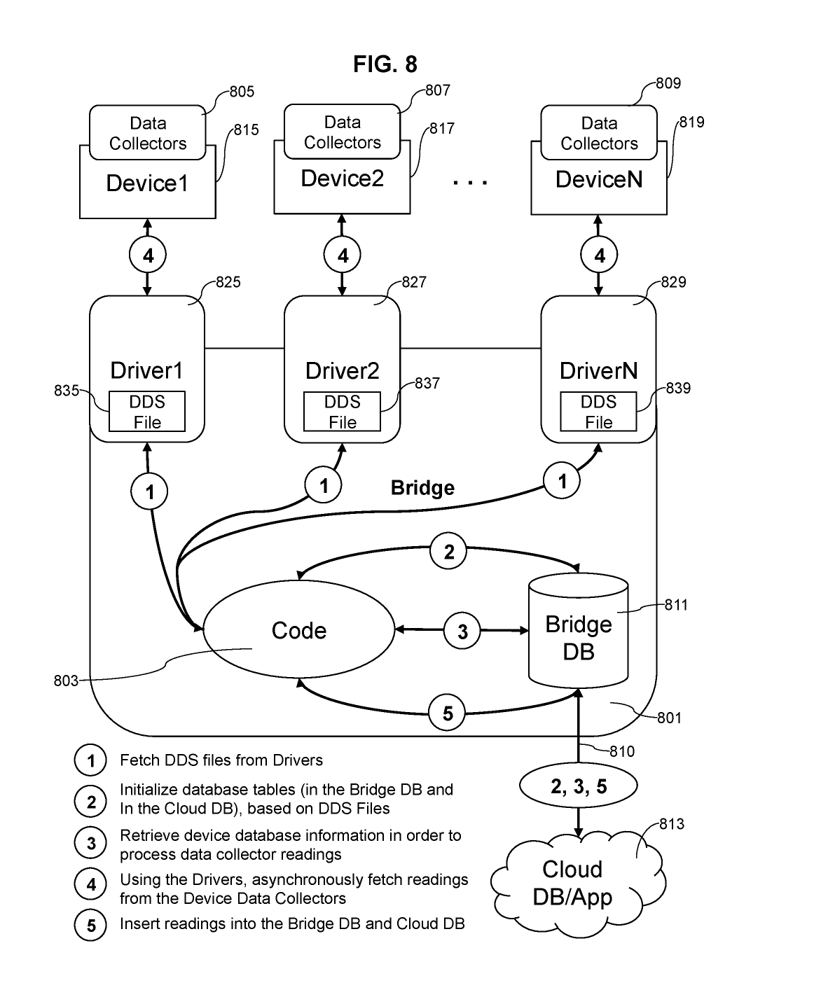

FIG. 8 illustrates the functional relationship and operation of a preferred data bridge software architecture 801. As illustrated in FIG. 1 or 2, the data bridge, either 120 or 122, may communicate to plurality of devices, device I, device II . . . Device N, 815, 817, or 819, connected to the local area network 102. Each of these devices may have its own local Data Collector 805, 807, or 809. Communication between the data bridge, 120 or 122, through the respective physical layer, as illustrated in FIG. 1 or 2, is by device driver, respectively device driver I device 825, device driver II 827, and device driver N 839. Each of these device drivers is specific to the kind of the device to which it is connected for communication purposes. Associated with each of these drivers, 825, 827, 829 is a DDS file, 835 837 or 839. A DDS file is a device data structure that specifies the type of data to be collected from the device according to type or kind. The heart of the data bridge software 801 is a core application code 803, which corresponds to the bridge core 130 of FIG. 3.

This core code 803 communicates with each of the device drivers and in turn communicates with local a data bridge database 811 and a cloud DB/application 813 through the Internet 810. After the master-slave relationship is created between the local bridge database 811 and remote cloud database 813, 103 as discussed previously, an update to the bridge database 811 is automatically communicated to provide an update to the cloud database 813, 103.

In operation, the core code 803 fetches DDS files 835, 837, 839, from the drivers 825, 827 or 829 and utilizes these to create the local bridge database 811 and the cloud database 813 based upon the DDS file structure. Thereafter the core code software 803 uses the device drivers, a 25, 827 or 829 to gather data respectively from the devices 815, 817, 819, which may also have local data 805, 807 or 809 collectors, that may provide data to the bridge 801 via the respective drivers. The data is then used to populate the local database which then by its master-slave relationship to the cloud database populates the cloud database.

Table II below illustrates the pseudocode necessary for the particular DDS structure, the database structure and the device set up.

TABLE II
IoT Atom Pseudo Code

```
  IoT Atom Pseudo Code
  I. Device Data Structure (DDS):
      manufacturer_name (string)
      model_name (string)
      connection_id (e.g. IP Address, Bluetooth Device ID, etc. -- string)
      data_collector1_type (string - unique to this device model)
      data_collector1_data_type (e.g. integer, decimal, varchar, etc. --
      string)
      data_collector2_type (string - unique to this device model)
      data_collector2_data_type (e.g. integer, decimal, varchar, etc. --
      string)
      data_collectorN_type (string - unique to this device model,
      where N is the
maxiumum number of data collectors for this device model)
      data_collectorN_data_type (e.g. integer, decimal, varchar, etc. --
      string, where N
is the maxiumum number of data collectors for this device model)
  data_collector_types are the types of data collectors available for
  this device.
III. Pseudo Code for Device Setup
function db_initialize(device_uuid, DDS)
{
        String DataCollectorsPKs;
        String DataCollectorColumns;
        foreach (DDS.DataCollectors as increment => DataCollector)
        {
              DataCollectorsPKs .= execute_query(‘INSERT INTO
              data_collectors
                    (CollectorType, CollectorDataType)
                    VALUES
                    (‘.DataCollector->Type.’,
                    ‘.DataCollector.DataType.’);’
          ).‘,’;
              DataCollectorColumns .=
              ‘ DataCollector’.increment.‘FK int ’;
        }
        execute_query(‘CREATE TABLE ‘.device_uuid.’
        (
              PK int,
              ConnID varchar(255),
              ‘.DataCollectorColumns.’
        );’);
        execute_query(‘ INSERT INTO ‘.device_uuid.’
              (ConnID, ‘.DataCollectorColumns.’)
              VALUES
              (‘.DDS->ConnectionID.’,‘.DataCollectorsPKs.’);’
        );
}
Device_drivers = fetch_all_device_drivers( );
foreach (Device_drivers as Driver)
{
    //If the device exists
    if (Driver.ping_device( ))
    {
        curr_DDS = read_driver_DDS_file(Driver);
        curr_device_uuid = generate_uuid_from_DDS(curr_DDS);
        if (!db_initialized(curr_device_uuid))
        {
            db_initialize(curr_device_uuid, curr_DDS);
        }
        db_info = get_db_info_for_device(curr_device_uuid);
        asynchronous_get_readings(Driver, curr_DDS, db_info);
    }
}
function asynchronous_get_readings(Driver, curr_DDS, db_info)
{
        while(Driver.has_readings( ))
          {
              Reading = Driver.get_reading( );
              foreach(Reading as DataCollectorType => DataValue)
              {
                DataType = db_info->getDataType(DataCollectorType);
                CollectorFK =
                db_info->getDataCollectorFK(DataCollectorType);
                if (is_numeric(DataType))
                {
                      execute_query(‘INSERT INTO readings
                        (TimeStamp, ValueNumeric, CollectorFK)
                        VALUES
                      (‘.Reading->TimeStamp.’,‘.DataValue.’,
                      ‘. CollectorFK.’);’
                      );
                }
                else
                {
                      execute_query(‘INSERT INTO readings
                        (TimeStamp, ValueString, CollectorFK)
                        VALUES
                      (‘.Reading->TimeStamp.’,‘.DataValue.’,
                      ‘. CollectorFK.’);’
                      );
                  }
              }
        }
}
```

The database 811, 813 is designed such that each customer account has a database. The database is preferably named—acccount_name_account_number. In addition, each dynamically created table in the database is named—manufacturer_name_model_name (first 2 parameters from the DDS)(See Table II).

When putting a device on the network, the data bridge software (core code software) 803 automatically detects (from the DDS) if this device has a table already existing in the database and, if not, it creates one, based on the first two parameters from the DDS. The data bridge software (core code software) 803 then detects whether this is a new device or a replacement device using the first three parameters of the DDS. If a new device, appropriate record(s) are added to its database table; if a replacement device, appropriate record(s) are updated (if needed) in its database table.

### Alternative Embodiments

In some embodiments the Network shown in FIG. 1 may implement a dedicated piece of hardware with a dedicated or shared processor to host and run the Data Bridge Application.

In some embodiments the Network used by the Data Bridge shown in FIG. 1 may consist of multiple networks connected in a cascade, tar or other configuration.

In some embodiments the Network shown in FIG. 2 may use a central or integrated or existing piece of hardware, such as a Router, Switch, Cell Phone or other Mobile Device, with a dedicated or shared processor to host and run the Data Bridge Application.

In some embodiments the Network shown in FIG. 2 may consist of multiple networks connected in a cascade, star or other configuration.

In some embodiments the Network shown in FIG. 1 and FIG. 2 may use communication other than Ethernet to connect and transfer data between the Bridge and the Nodes.

In some embodiments the Network shown in FIG. 1 and FIG. 2 may convert communication other than Ethernet to an Ethernet communications such that a given Network Node can communication with the Data Bridge over the Network.

In some embodiments the Network shown in FIG. 1 and FIG. 2 may use a combination of one or more types of communication layers on a single network.

In some embodiments the Network shown in FIG. 1 and FIG. 2 may use a combination of one or more types of communication layers across multiple networks.

In some embodiments the Network shown in FIG. 1 and FIG. 2 may connect communication other than Ethernet to an Ethernet directly to the Data Bridge.

In some embodiments any number of the Network Nodes as shown in FIG. 1 and FIG. 2 will support a Node Type ping command such that they will send their Node Type and can automatically detected and automatically configured by the Data Bridge.

In some embodiments some or all of the Network Nodes, as shown in FIG. 1 and FIG. 2, will be generic Network Nodes such that they require manual assignment of the Network Node Drivers.

In some embodiments the configuration and set up of the Network Nodes, as shown in FIG. 1 and FIG. 2, will be performed using a Graphical User Interface.

In some embodiments the configuration and set up of the Network Nodes, as shown in FIG. 1 and FIG. 2, will be performed via command line interface.

In some embodiments the Data Collection and Control Network, as shown in FIG. 1 and FIG. 2, will have a combination of Peripheral Nodes that accept control information and Sensor Nodes that send collected data to the database.

In some embodiments the Data Collection and Control Network, as shown in FIG. 1 and FIG. 2, will only have Peripheral Nodes that accept control information.

In some embodiments the Data Collection and Control Network, as shown in FIG. 1 and FIG. 2, will only have Sensor Nodes that send collected data to the database.

In some embodiments the Data Bridge Software will use drivers or software modules that hold parameters and/or information such as data structures, data types, etc. that are used to define and create the database structure for storing the data that is sent or received by the Network Node associated with the given driver or module.

In some embodiments the local database will store data for a limited window of time and sync the data for this limited window to the remote database, such that data from a time prior to this limited window of time will remain in the remote database after the master/slave sync process takes place.

1. In a network wherein a plurality of different data gathering device types comprise one or more network nodes and a data bridge device that may communicate through the network to such one or more network nodes either directly or indirectly through a router, a method comprising:
providing a data bridge device driver for each of said plurality of different data gathering device types; and
associating with each data bridge device driver a device data structure file.

2. The method according to claim 1 wherein a device data structure file comprises parameters, descriptions and information that define a database table.

3. The method according to claim 1, wherein the data bridge device uses a device data structure file to define a database table.

4. The method according to claim 3, wherein the data bridge device populates the database table with data from a data gathering device connected to node on the network.

5. The method according to claim 1, wherein the data bridge device comprises a router.

6. The method according to claim 1 wherein the data bridge device determines the type of a data gathering device connected to a node.

7. The method according to claim 6 wherein the data bridge device employs a data bridge device driver for the data gathering device type determined.

8. The method according to claim 3, wherein the data bridge device database table is a cloud database table.

9. The method according to claim 1, wherein the data bridge device uses a device data structure file to define a local database table and a cloud database table.

10. The method according to claim 1, wherein the data bridge device uses a device data structure file to define a local database table and a cloud database table and slaves the cloud database table to the local database table.
